(19) United States
(12) Patent Application Publication
(10) Pub. No.: US 2011/0033827 A1
(43) Pub. Date: Feb. 10, 2011

(54) Method of using dental material and composite dental material formed by using hydroxyapatite

(76) Inventors: Mitsunori Ishimoto, Tokyo (JP); Hidesato Hara, Tokyo (JP)

Correspondence Address: JACOBSON HOLMAN PLLC, 400 SEVENTH STREET N.W., SUITE 600, WASHINGTON, DC, 20004, US

(21) Appl. No.: 12/805,405

(22) Filed: Jul. 29, 2010

Related U.S. Application Data
(62) Division of application No. 11/661,119, filed on Jun. 21, 2007.

(30) Foreign Application Priority Data
Dec. 16, 2005 (JP) 2005-364010

(51) Int. Cl. A61C 19/06

(52) U.S. Cl. 433/215

(57) ABSTRACT

A dental material formed by using a hydroxyapatite, which is suitable for performing a guided bone regeneration (GBR) method in the implant therapy of dentistry. Also, a composite dental material which is a bioabsorbable film provided integrally with hydroxyapatite is capable of rapidly attracting osteoblast and blocking fibroblast. The dental material is a membrane for a guided bone regeneration method of guiding a bone formation by preventing invasion by anaplastic fibroblast by covering a bone developing site with a blocking membrane and filling the bone developing site with osteoblast, wherein a main body of the blocking membrane is formed by using hydroxyapatite having osteoconductive capability of rapidly attracting osteoblast for the purpose of disposing the hydroxyapatite at a bone developing site side of the membrane main body.

This application is a Divisional of application Ser. No. 11/661,119 filed Jun. 21, 2007, which in turn is a national stage of PCT/JP06/325565 filed Dec. 15, 2006.

### FIELD OF THE INVENTION

This invention relates to a dental material using hydroxyapatite (HA), which is to be used for a guided bone regeneration method of guiding bone formation by preventing invasion by the anaplastic fibroblast by covering a bone developing site with a blocking membrane and filling the bone developing site with the osteoblast as well as to a composite dental material which is a bioabsorbable membrane provided integrally with hydroxyapatite.

### BACKGROUND ART

In implant therapy in current dentistry, for example, there are demands for a departure from the conventional implant therapy wherein tooth planting is the primary object and know-how for embedding an implant more aesthetically, functionally, and at an ideal position. For such demands, necessity for bone development has been recognized, resulting in establishment of the GBR method.

GBR is an abbreviation for Guided Bone Regeneration, and, in accordance with the generally accepted concept, the GBR method is a method for guiding bone formation by preventing invasion by the anaplastic fibroblast by covering a bone developing site with a blocking membrane and filling the bone developing site with the osteoblast. As the blocking membrane, two types of membranes, namely a non-absorbable membrane and an absorbable membrane, are used.

Though the non-absorbable membrane is capable of reliably preventing the invasion by fibroblast for long term, a risk of exposure of such blocking membrane is undesirably high since the mucosa covering the membrane can sometimes be divulged. According to the generally accepted point of view, the exposure problem occurs more frequently with the Mongoloids whose mucosa is relatively thin. In turn, though the absorbable membrane is reduced in exposure risk, it is difficult to block the fibroblast for a long term since the absorbable membrane is rapidly absorbed in vivo.

In view of the foregoing, JP-A-7-236688 discloses the invention of a membrane for increasing the alveolar bone, which has a three layer structure of a collagen sponge layer, a bioabsorbable plastic coating layer, a hydroxyapatite-containing collagen sponge layer. However, for the purpose of achieving the increase of the alveolar bone, the invention utilizes a guided tissue regeneration method (GTR method) wherein a space is formed in the vicinity of a tooth and the alveolar bone to isolate the bone tissue growing from the alveolar bone via the tooth from interference by the soft tissue.

### SUMMARY OF THE INVENTION

This invention has been accomplished in view of the above-described points, and an object thereof is to provide a dental material formed by using hydroxyapatite, which is suitable for practicing a guided bone regeneration (GBR) method in a dental implant therapy. Also, another object of this invention is to provide a composite dental material that is a bioabsorbable membrane provided integrally with hydroxyapatite and is capable of rapidly attracting the osteoblast and blocking the fibroblast.

In order to solve the above problems, this invention implements a membrane to be used for a guided bone regeneration method of preventing invasion by anaplastic fibroblast by covering a bone developing site with a blocking membrane and guiding bone formation by filling the bone developing site with osteoblast, wherein a membrane main body of the membrane is formed by using hydroxyapatite having osteoconductive capability of rapidly attracting the osteoblast in order to dispose the hydroxyapatite on a bone developing site part. The above-described dental material is the single membrane comprising hydroxyapatite, and this invention further encompasses a dental material that has a composite structure wherein a membrane main body of a blocking membrane is formed from a bioabsorbable membrane, and hydroxyapatite having osteoconductive capability for rapidly attracting the osteoblast is disposed on a bone developing site part of the membrane main body.

As is apparent from the above-described structure, since this invention enables to guide the bone formation by forming a space that is prevented from invasion by the anaplastic fibroblast by covering the bone developing site with the blocking membrane and filling the space with the osteoblast, it is possible to compare this invention with the GBR method. The GBR method is an application of the GTR method to the bone tissue regeneration, while this invention has the object of regeneration of a bone defect.

The dental material according to this invention is in the form of a single membrane comprising hydroxyapatite or is in the form of a membrane comprising two elements of the membrane main body formed from the bioabsorbable membrane and hydroxyapatite, and each of the dental materials takes the form of a membrane. The bioabsorbable membrane takes various forms, and it is necessary to block the fibroblast for a certain period of time in this invention. As used herein, the certain period of time means a period during which the space of the bone developing site covered with the blocking membrane is filled with the osteoblast so as to prevent the invasion by anaplastic fibroblast.

Examples of the bioabsorbable membrane satisfying the above conditions include a collagen membrane, a lactic acid/glycol acid copolymer, and the like. Among the above, the collagen membrane is the most preferred.

Hydroxyapatite which is one of elements for forming the dental material and the composite dental material of this invention has the osteoconductive capability of rapidly attracting the osteoblast. Therefore, the hydroxyapatite is used alone for forming the dental material of this invention or disposed on the bone developing site side of the membrane main body which is a separate material to obtain the composite structure. It is intended to accelerate the bone formation by attracting the osteoblast by the presence of hydroxyapatite in the bone developing site side of the membrane main body. Thus, a bone formation period is reduced.

In order to dispose the hydroxyapatite having osteoconductive capability of rapidly attracting the osteoblast on the bone developing site side of the membrane main body, hydroxyapatite in the form of a film is used as the dental material for forming the membrane main body of the blocking membrane by using hydroxyapatite. The hydroxyapatite film takes the form of a sheet and has the size of perfectly covering an affected area and a thickness for preventing invasion by the fibroblast during appropriately proceeding the bone development. It cannot be said that the hydroxyapatite membrane is bioabsorbable, but hydroxyapatite is a main ingredient of teeth and does not cause any trouble if it remains. Therefore, both non-absorbable hydroxyapatite and slowly-absorbable hydroxyapatite may be used in this invention.

In the case of using the hydroxyapatite in combination with the membrane main body, the hydroxyapatite is disposed on the bone developing site side of the membrane main body and fixed by a certain method. The fixing may be temporary or permanent. That is, it is sufficient to maintain a state wherein the hydroxyapatite is adhered to the membrane main body so that the membrane main body is provided integrally with the hydroxyapatite. Therefore, it is possible to employ an appropriate fixing method depending on the form of the hydroxyapatite such as a powder, particles, a liquid, a gel, and a sheet.

Typical application examples of the hydroxyapatite fixing method include application of hydroxyapatite dissolved into a solvent on the bone developing site side of the membrane main body. With such fixing method, it is possible to appropriately fix the hydroxyapatite to the membrane main body formed from the bioabsorbable membrane.

A region to which the hydroxyapatite is to be fixed may be a whole part or a part of the bone developing site side of two sides of the membrane main body. Other examples of the fixing method may be dipping of the membrane main body into a hydroxyapatite solution dissolved into a solvent, and this method is one of typical application examples.

As described in the foregoing, the composite dental material which is the bioabsorbable membrane provided integrally with hydroxyapatite has at least two elements (the membrane main body formed from the bioabsorbable membrane and the hydroxyapatite), and this means that it is possible to add third or further elements and the like. Examples of the third element include a remedy accelerating unit capable of covering a surface of the hydroxyapatite. Examples of the remedy accelerating unit include platelet-rich plasma (PRP) and the like.

Since each of the dental material formed by using hydroxyapatite and the composite dental material which is the bioabsorbable membrane provided integrally with hydroxyapatite has the structure and the effects as described above, the bone formation is accelerated by the osteoblast that is attracted directly under the membrane rapidly by the hydroxyapatite with the mucosa exposure being avoided thanks to the advantages of the hydroxyapatite and the bioabsorbable membrane, and it is possible to block the fibroblast by the osteoblast attracted by the hydroxyapatite after the membrane is absorbed, thereby achieving the ideal effects that the hydroxyapatite and the bioabsorbable membrane redeem each other's shortcomings. By the above-described characteristics of rapidly attracting the osteoblast and blocking the fibroblast, appropriate practice of the guided bone regeneration (GBR) method in the implant therapy of dentistry is expected.

### BRIEF DESCRIPTION OF THE DRAWINGS

FIG. 1 is a perspective view showing Example 1 of a dental material according to this invention formed by using hydroxyapatite.

FIG. 2 is a partially exploded view showing Example of a composite dental material according to this invention formed by using hydroxyapatite.

FIG. 3 is a partially exploded perspective view showing Example 3 of a composite dental material according to this invention that is a bioabsorbable membrane provided integrally with hydroxyapatite.

FIG. 4 is a diagram showing one application example of the composite dental material according to this invention that is the bioabsorbable membrane provided integrally with the hydroxyapatite, wherein A is a sectional view showing a state of an affected area after incision; B is a sectional view showing a stage of embedding an implant; and C is a sectional view showing a stage of filling a bone graft material.

FIG. 5 is a diagram showing the rest of the application example of FIG. 4, wherein D is a sectional view showing a stage of inserting the composite dental material into a target site; E is a sectional view showing a stage of disposing the composite dental material of this invention to the target site; F is a sectional view showing a stage of fixing the composite dental material of this invention to the target site; and G is a sectional view showing a stage where the affected area is covered perfectly to wait for bone formation.

### REFERENCE NUMERALS

10: composite dental material of bioabsorbable membrane provided integrally with hydroxyapatite
10′: dental material formed by using hydroxyapatite
11: membrane main body
12: hydroxyapatite
13: remedy accelerating unit
15, 16: both sides of membrane main body of Example 1 formed from hydroxyapatite

### DESCRIPTION OF THE PREFERRED EMBODIMENTS

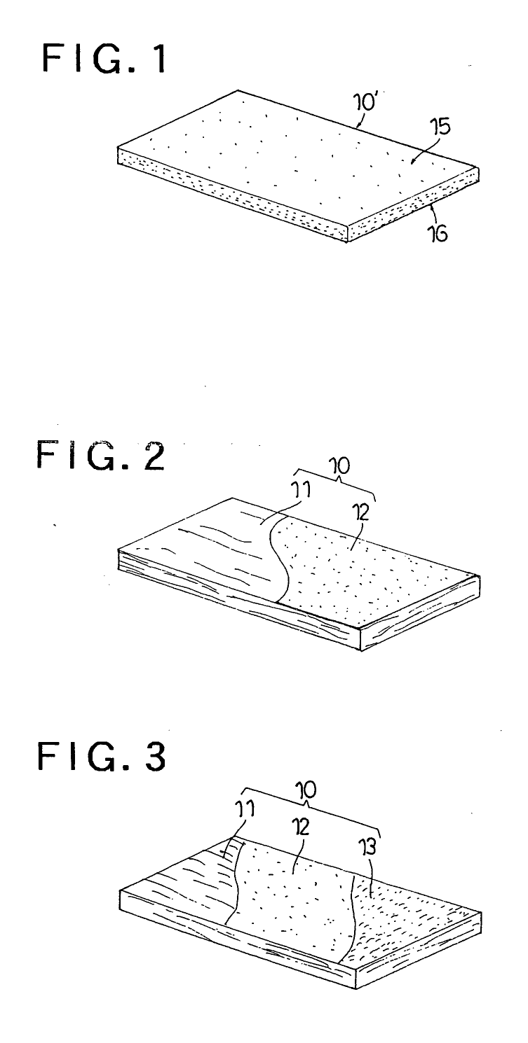

Hereinafter, this invention will be described in more detail with reference to embodiments shown in the drawings. Shown in FIG. 1 is Example 1 of a dental material 10′ formed by using hydroxyapatite. The dental material 10′ is obtained by molding the hydroxyapatite into a sheet-like shape having the size of 1×2 cm, 2×4 cm, or 2×2 cm in plan view and a thickness of 1 to several millimeters. Further, it is possible to achieve a structure wherein the hydroxyapatite of Example 1 is sandwiched by a bioabsorbable membrane from each of both sides 15 and 16.

Shown in FIG. 2 is Example 2 of a composite dental material 10 according to this invention, which is a bioabsorbable membrane 11 provided integrally with hydroxyapatite and has a two-layer structure of a membrane main body 11 formed from the bioabsorbable membrane and hydroxyapatite 12 disposed on and fixed to a bone developing site side of the membrane main body 11.

The membrane main body 11 is formed by using a collagen membrane which is a bioabsorbable membrane. Such membrane main body 11 is a living body-derived membrane such as a cow-derived or pig-derived membrane and has a film-like structure and a handy size in view of convenience in use.

The membrane main body 11 formed from the collagen membrane which is the bioabsorbable membrane functions as a blocking membrane for covering a bone developing site in the implant therapy in dentistry, for example, and used for the purpose of blocking the fibroblast for a certain period of time until a blocking function of the osteoblast is exhibited. In the composite material 10 of this invention, the one having a flat shape, the size of 1×2 cm, 2×4 cm, or 2×2 cm, and a thickness of 1 to several millimeters is usable in the dentistry for the above-described purpose.

The dental material 10′ and the membrane main body 11 have another function of covering the bone developing site to ensure a space, i.e. the function of being used as a constructional material for space-making in the GBR method. Therefore, the membrane main body 11 is required to satisfy conditions for bearing strength required as the constructional material. The above-described shape, dimensions, and the like satisfy the conditions.

The hydroxyapatite 12 has osteoconductive capability of rapidly attracting the osteoblast. In Example 1, the hydroxyapatite 12 is applied so that the hydroxyapatite 12 is disposed at least on the bone developing site side of the membrane main body 11. This is achieved by either one of a method of disposing the hydroxyapatite 12 on both of the bone developing site side and a non-bone developing site side of the membrane main body 11 or a method of impregnating an internal of the membrane main body 11 with the hydroxyapatite 12.

The hydroxyapatite 12 used for the examples is in the form of particles. The hydroxyapatite has an average particle diameter of 20 to 40 mesh or 40 to 60 mesh and is used as being mixed with a water soluble ointment base (Macrogol 400 produced by Sanyo Chemical Industries, Ltd., for example). More specifically, the hydroxyapatite 12 is fixed by applying the hydroxyapatite solution on a whole part of the membrane main body 11. When the solution is used, the hydroxyapatite 12 is fixed not so firmly in some cases, but the object is achieved insofar as the fixing state is maintained until the bone developing site is covered with the blocking membrane formed from the dental material 10 of this invention even when the fixing firmness is relatively weak.

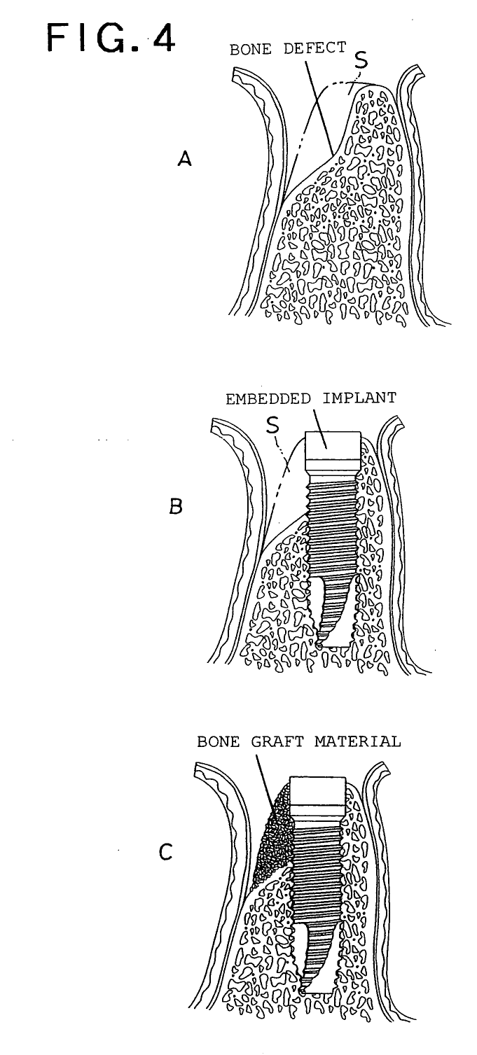

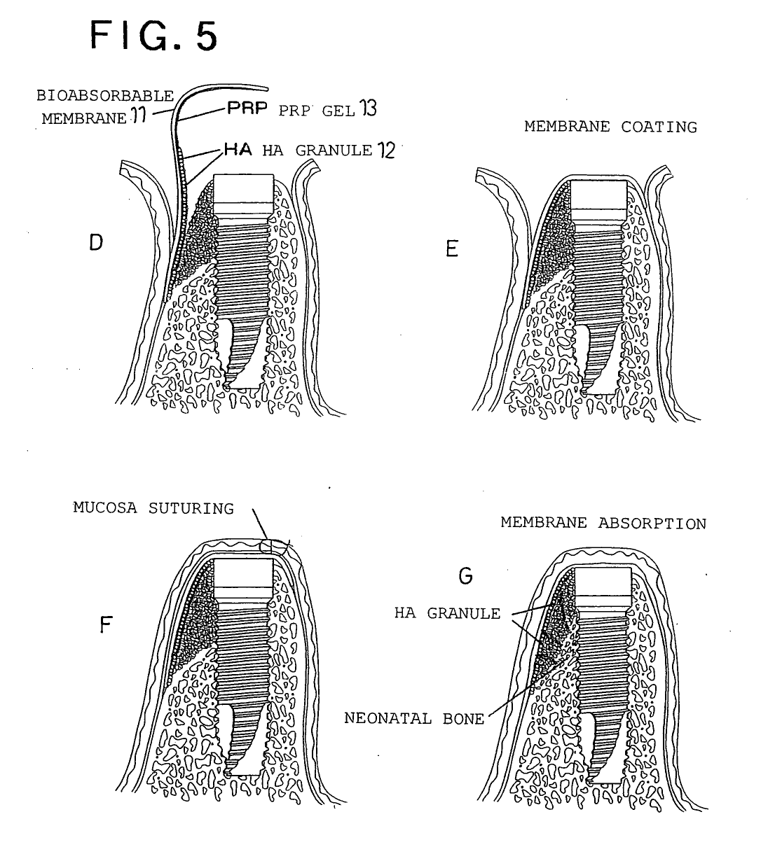

Shown in FIG. 3 is Example 3 wherein a surface of the hydroxyapatite 12 forming the composite dental material 10 of Example 2 shown in FIG. 2 is covered with a remedy accelerating unit 13. In the case of Example 3, the remedy accelerating unit 13 is formed from a platelet-rich plasma gel (PRP gel). It is also possible to fix the remedy accelerating unit 13 to the surface of the hydroxyapatite 12 by applying the remedy accelerating unit 13 on the surface. The dental material 10′ formed by using hydroxyapatite and the composite dental material 10 which is the bioabsorbable membrane provided integrally with hydroxyapatite of this invention are prepared under an antiseptic condition and applied on an affected site in use. Examples of the use in the implant therapy in dentistry will be described with reference to FIGS. 4 and 5.

Shown in FIGS. 4 and 5 is one example of performing bone development for the purpose of embedding an implant into the alveolar bone wherein a bone defect has occurred. Shown in FIG. 4A is a state in which the bone defect is exposed by incising the gingiva of the affected site to form a flap, and shown in FIG. 4B is a state in which a required implant is embedded at a target position. The portion enclosed by the two dot chain line is a space S for bone development which is to be covered by the blocking membrane according to this invention for the purpose of prevention of invasion by the anaplastic fibroblast. After performing a predetermined drilling of the alveolar bone to reach the spongy bone, the space S is filled with a bone graft material (FIG. 4C).

Then, the composite dental material 10 of this invention of the bioabsorbable membrane, for example, provided integrally with hydroxyapatite is used as a blocking membrane (FIG. 5D). More specifically, the hydroxyapatite 12 is disposed in such a fashion as to face the space S which is the bone developing site and to cover the bone graft material filled in the space S. The composite dental material 10 shown as the example has the remedy accelerating unit 13 and perfectly covers the bone graft material filled in the space S (FIG. 5E). When the flap of the mucosa is sutured, the composite dental material 10 is in the fixed state (FIG. 5F).

By suturing the mucosa, the composite dental material 10 of this invention is enclosed inside the mucosa to be fixed therein. Therefore, insofar as the hydroxyapatite 12 is fixed to the bone developing site side of the membrane main body 11 until this stage, the hydroxyapatite 12 achieves its object even when the fixing force is not so strong since the hydroxyapatite 12 will not be broken or the like after this stage. After that, by the biological activity, a neonatal bone is generated from the alveolar bone over time. By the osteoconductive capability of the hydroxyapatite 12 of the composite dental material 10, the osteoblast is rapidly and positively attracted, so that acceleration of the bone formation is expected (FIG. 5G).

The rapid bone formation is achieved directly under the membrane as described above, and then the membrane main body 11 is absorbed in vivo over time. After the membrane absorption, the osteoblast attracted by the hydroxyapatite 12 exhibits its blocking function to block the fibroblast. Thus, it is possible to achieve the appropriate bone development with the use of the hydroxyapatite membrane or the bioabsorbable membrane by making use of the advantage of reduced mucosa exposure risk and blocking the fibroblast.

1. A guided bone regeneration method comprising
guiding a bone formation so as to prevent invasion by anaplastic fibroblast by covering over a bone developing site with a blocking membrane,
filling the bone developing site with osteoblast,
forming a main body of the blocking membrane by using hydroxyapatite having an osteoconductive capability of rapidly attracting osteoblast,
disposing the hydroxyapatite at a side of the bone developing site of the main body so as to position the osteoblast between the bone developing site and the main body, and
suturing a flap of the mucosa to enclose the blocking membrane inside the mucosa and the blocking membrane being fixed therein.

2. The method according to claim 1, wherein a layer of the hydroxyapatite is sandwiched between a bioabsorbable membrane located at each of both sides thereof.

3. A guided bone regeneration method comprising
guiding a bone formation so as to prevent invasion by anaplastic fibroblast,
covering a bone developing site with a blocking membrane,
filling the bone developing site with osteoblast,
forming a main body of the blocking membrane by using a bioabsorbable membrane,
providing the bioabsorbable membrane with hydroxyapatite having osteoconductive capability of rapidly attracting osteoblast,
disposing the blocking membrane at a side of the bone developing site of the main body so as to position the osteoblast between the bone developing site and the main body, and
suturing a flap of the mucosa to enclose the blocking membrane inside the mucosa and the blocking membrane being fixed therein.

4. The method of claim 3, wherein the bioabsorbable membrane is a collagen membrane.

5. The method of claim 3, wherein the hydroxyapatite is fixed to the main body by being dissolved into a solvent and applied on the side of the bone developing site of the main body.

6. The method of claim 3, wherein the hydroxyapatite is fixed to the main body by being dissolved into a solvent and dipping the main body into the hydroxyapatite solution.

7. The method of claim 3, wherein a surface of the hydroxyapatite is covered with a remedy accelerating unit.

8. The method of claim 1, wherein the hydroxyapatite is disposed only proximate to the bone developing site.
